(19) United States
(12) Patent Application Publication
(10) Pub. No.: US 2021/0273809 A1
(43) Pub. Date: Sep. 2, 2021

(54) METHOD FOR SECURING VEHICLE COMPONENTS AND CORRESPONDING VEHICLE COMPONENT

(71) Applicant: Volkswagen Aktiengesellschaft, Wolfsburg (DE)

(72) Inventor: Simon Gerlach, Meine (DE)

(21) Appl. No.: 17/254,773

(22) PCT Filed: Jun. 21, 2019
(86) PCT No.: PCT/EP2019/066489

§ 371 Date: Dec. 21, 2020

(30) Foreign Application Priority Data
Jun. 25, 2018 (DE) 10 2018 210 318.6

(51) Int. Cl. H04L 9/32; H04L 9/06; G06F 21/64; H04W 12/03

(52) U.S. Cl. CPC H04L 9/3236; H04L 9/0643; H04L 2209/38; H04W 12/03; H04L 2209/84; G06F 21/64

(57) ABSTRACT

Technologies and techniques for securing vehicle components, wherein data regarding vehicle use are captured by at least one vehicle component. A data structure is produced, which contains a list of captured data regarding vehicle use, the captured data being stored in blocks, which are linked together in that each block contains a cryptographic checksum of the preceding block. The data structure is stored in a plurality of vehicle components of the vehicle.

### RELATED APPLICATIONS

The present application claims priority to International Pat. App. No. PCT/EP2019/066489, filed Jun. 21, 2019, to Simon Gerlach, titled “Method for Securing Vehicle Components and Corresponding Vehicle Component”, which further claims priority to German Patent Application No. DE 102018210318.6 to Simon Gerlach, filed Jun. 25, 2018, the contents of which is incorporated by reference in its entirety herein.

### BACKGROUND

The present disclosure relates to technologies and techniques for safeguarding vehicle components. The present disclosure also relates to a vehicle component that executes such a method, and a motor vehicle that is configured to execute methods disclosed herein, and/or contains numerous such vehicle components.

In the automotive industry there is a significant desire to effectively protect electronic vehicle components and control units against manipulation and theft. It is therefore currently assumed in Germany, that the mileage reading in every third used automobile has been manipulated, and the mileage gauge that displays the mileage, which is normally combined with the tachometer, or is integrated in the dashboard, indicates an inaccurately low mileage.

This can take place through tachometer manipulation in which a manipulating device is connected to the on-board diagnostics port (OBD), and the prior mileage is overwritten. Such a manipulation is simple, because it requires no removal of components. Furthermore, these manipulations are difficult to prove. A vehicle can also display an inaccurate mileage if the vehicle component comprising the mileage gauge originally installed during production is replaced with a legally or illegally obtained corresponding vehicle component.

To prevent tachometer manipulation, or at least make it more difficult, a redundant mileage reading is frequently stored in numerous control units in the vehicle. If the mileage is then overwritten in just one control unit, a manipulation can be detected by comparing the various stored mileage readings.

Use of blockchain technologies against tachometer manipulation have also been considered. The mileage readings from numerous vehicles are sent at regular intervals to external servers, to be stored in a public blockchain data base. DE 10 2016 007 462 A1 and DE 10 2016 215 914 A1 describe approaches for this.

Likewise, the use of stolen or fake components, or components that are not authorized for the vehicle, should be made unattractive by the so-called component protection for diverse vehicle components. In this case, a vehicle component can either be taken out of operation, or its scope of functions can be reduced, if it is installed in a vehicle other than the original. Various methods are known for detecting whether the vehicle component in question has been installed in another vehicle.

A unique identification code is generated in each protected vehicle component in a decentralized implementation by a parameterization during the vehicle production or the first time it is started up. These identification codes are sent out by the protected vehicle components and received by the vehicle bus every time the vehicle is started up. The respective vehicle components store the identification codes for the remaining vehicle components that are to be protected, installed in the same vehicle before it has acquired this data, i.e. in the first operation thereof, or after a reset by an authorized entity. When later starting up after acquiring the data, they then compare the identification codes of the vehicle components that have been identified in the vehicle with the stored identification codes. If a vehicle component detects deviations above a specific threshold, e.g. more than one deviating protected vehicle component, it assumes that it is installed in another vehicle, and initiates appropriate measures.

With a central implementation, a key A for each protected vehicle component is stored in a central control unit, e.g. a gateway that coordinates the data transfer within the network system for the vehicle, and a matching key B is stored in the protected vehicle component. The central control unit and the protected vehicle components can then communicate with one another via encryption methods to determine whether the expected matching key is stored in the counterpart. In this manner, the protected vehicle components can determine whether they have been installed in the vehicle for which they were configured. The central control unit can also determine whether all of the protected vehicle components are still installed in the vehicle.

### SUMMARY

An aspect of the present disclosure is to create an improved method for protecting vehicle components against manipulation and theft, and to provide a corresponding vehicle component.

In some examples, technologies and techniques are disclosed for protecting vehicle components that may include the following steps:
acquiring data regarding vehicle use by at least one vehicle component;
generating a data structure containing a list of acquired data, wherein the acquired data are stored in blocks that are linked together in that each block contains a cryptographic checksum from the preceding block;
storing the data structure in numerous vehicle components in the vehicle.

Information vulnerable to manipulation, e.g. mileage readings, can therefore be protected by the distributed storage of the data regarding vehicle use in numerous vehicle components. At the same time, components can be protected with the method. In this manner, a single method can therefore contain measures for preventing data manipulation, and also protect the components. Furthermore, this takes less time in the vehicle production than known component protection methods, because individual keys or identification codes for the vehicle and control unit do not need to be generated and placed in the protected vehicle components. Furthermore, in contrast to the centralized method specified above, it is no longer necessary to permanently store the key or its fundamental information, because after an authorized partial exchange of a vehicle component, the same key for the vehicle can be put in place in this manner.

In some examples, technologies and techniques are disclosed for protecting motor vehicle components that include the steps of:
supplementing the data structure stored in a first vehicle component with a block containing further information regarding vehicle use, wherein the block is added by this first vehicle component, and the added block contains a cryptographic checksum for the previously last block in the data structure;
sending the new block to at least one of the other vehicle components; and
checking the validity of the added block using the cryptographic checksum contained therein, and a local version of the data structure present in the at least one other vehicle component.

In some examples, the validity of the added block is checked by numerous vehicle components, and it is decided by a majority decision whether the new block will be accepted. The protection provided by the method can be significantly increased with this simultaneous validity check by numerous vehicle components.

Advantageously, if the check for the added block delivers a positive result, the supplemented data structure is stored in the at least one other vehicle component.

It is also advantageous, if the check for the added block delivers a negative result, when the scope of functions for the first vehicle component is restricted, or this component is taken out of operation in the vehicle.

It is particularly advantageous if a vehicle component in which a data structure has not yet been stored, initially acquires the first data structure received from one of the other vehicle components.

According to another embodiment of the present disclosure, the data structure stored in a vehicle component that was initially installed in another vehicle for authorizing the operation of the component in another vehicle is deleted.

According to another embodiment of the present disclosure, the version of data structure most frequently found in the data structures in the various vehicle components in the vehicle is used.

The data regarding vehicle use advantageously comprise the mileage of the vehicle.

A method according to the present disclosure is preferably implemented in numerous vehicle components in a motor vehicle.

### BRIEF DESCRIPTION OF THE DRAWINGS

Further features of the present disclosure are explained in the following description and claims, and illustrated in the figures. Therein:

FIG. 1 shows a schematic illustration of an exemplary embodiment of the method for protecting vehicle components under some aspects of the present disclosure;

FIG. 2 shows a schematic illustration of a data structure used for executing the method according to some aspects of the present disclosure, which has blocks generated by vehicle components, that contain data regarding vehicle use; and

FIG. 3 shows a schematic illustration of an exemplary grouping of three vehicle components (A), in which the data structure is supplemented with a new block, which contains a newly detected mileage reading (B), checking the new blocks (C, E) as well as the respective results for both positive (D) and negative (F) results of the check under some aspects of the present disclosure.

### DETAILED DESCRIPTION

For a better understanding of the principles of the present disclosure, embodiments of the present disclosure shall be described below in detail in reference to the drawings. It should be noted that the present disclosure is not limited to these embodiments, and that the features described herein can also be combined or modified without abandoning the scope of protection for the present disclosure as set forth in the claims.

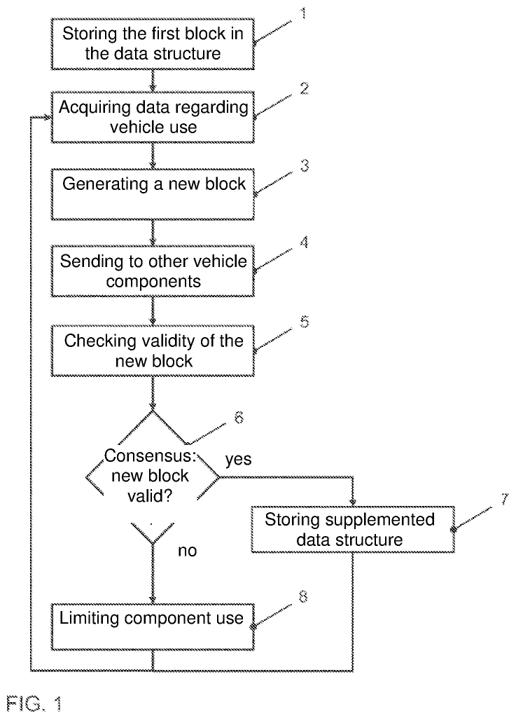

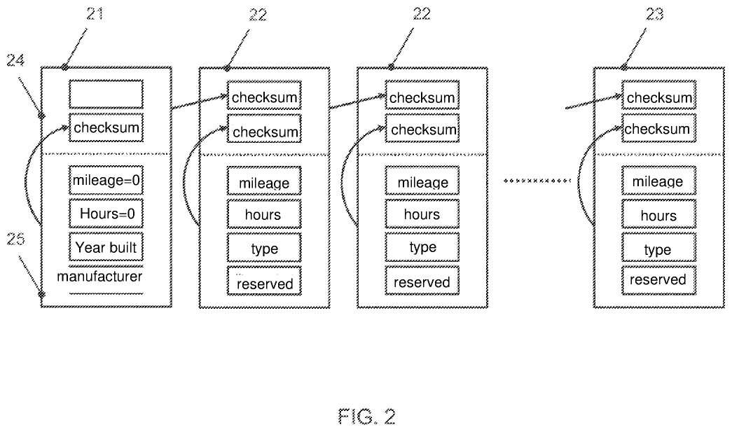

FIG. 1 shows a schematic illustration of an exemplary embodiment of the method according to the present disclosure for protecting vehicle components in a vehicle. The vehicle components can be protected in particular on the basis of a data structure such as the so-called blockchain structure. In addition to the component protection, it is also possible to store data regarding vehicle use such that it is protected against manipulation, e.g. the mileage reading, or a vehicle log with details regarding past usage of the vehicle, hours in operation, accidents, and maintenance. Details of the data structure shall be explained below in reference to FIG. 2.

In a first step 1, the first block of the data structure is stored in a vehicle component in the vehicle if no data structure has been previously stored, or after deleting the existing data structure. In a blockchain, this first block is also known as a so-called genesis block. This first block is not computed by a vehicle component, but instead predefined statically.

In the second step 2, data regarding vehicle use is then acquired from the vehicle components. The data regarding vehicle use are understood herein to be arbitrary parameters concerning the vehicle, that are determined at a specific point in time. As such, the following data regarding vehicle use can be acquired:
mileage reading;
information regarding times of use, e.g. the points in time at which the vehicle is started up and parked, or the durations of the respective vehicle uses (“hours in operation”);
information regarding where the vehicle is parked, e.g. GPS coordinates;
clear indicators of the respective uses via IDs that have been agreed on, or random numbers.

Other data substantial to the vehicle use can also be collected, e.g. data that are subject to an acquisition requirement according to legal stipulations, or information regarding whether the vehicle is in a manual, semiautomatic, or autonomous driving mode, or when it is switched from one of these modes to another driving mode.

The collection of the data can be used to determine, e.g. times or reasons for starting or stopping vehicle use, e.g. in the case of an accident or for repairs, or at regular intervals, without requiring a specific event. This can also take place when modifying the detected parameters by a predefined amount or the time at which a vehicle component is actuated.

The acquired data are then entered in a third step 3 in a new block, and protected by computing a checksum for this new block. The checksum is acquired in the new block and enables a later check of the integrity of the data. The checksum of the previously last block in the data structure is then acquired in the new block, in order to link the new block locally to the existing data structure.

This can take place in a decentralized manner by the vehicle component that has acquired the data. A new block can also be formed in a centralized manner by a special vehicle component responsible for this, e.g. a central control unit, which can then combine potentially new entries of various data regarding vehicle use in the new block.

Because the data structure is decentralized on the various vehicle components, they must agree to any expansion of the data structure. For this, the vehicle component containing the new block sends the new block, or the complete data structure supplemented by the new block, to the other vehicle components in the vehicle in the fourth step 4. This data exchange among the protected vehicle components can take place at regular intervals, or immediately after acquiring the new data or the generation of a new block.

In the fifth step 5, the new block is checked by the other vehicle components. Each receiver first checks whether the new block is valid based on the checksum.

Using a consensus algorithm, which in the simplest case makes a simple majority decision, it is then decided in the sixth step 6 whether the new block will be accepted. Such a majority decision can be met, for example, in that a majority, or even just more than half of the participating vehicle components have accepted the new block when all of the other vehicle components participating in the check have validated the checksum.

This can be circumvented, e.g. if manipulation is intended, in that a majority or all of the other vehicle components participating in the check are exchanged, but this would be extremely complicated and uneconomical. It is therefore almost impossible to manipulate the mileage reading in a vehicle, if this would require that in addition to manipulating the control unit that generates the mileage reading, all of the other control units, e.g. for the engine, transmission and steering system, have to be replaced to obtain a consensus.

Vehicle components that can be readily accessed and easily removed can therefore be protected against theft by grouping them with vehicle components that are difficult or complicated to replace.

The validations by the various vehicle components can also be weighted differently, in that vehicle components that are more difficult to remove are given a higher value.

If a consensus is reached in the sixth step 6 that the new block is valid, it is then added in a seventh step 7 to the data structure in the vehicle.

If there is a deviation from the checksum in step 6 when checking the new block in most of the other vehicle components, the use of the vehicle component that wants to add the new block to the data structure in the vehicle is then limited in the eighth step 8.

FIG. 2 shows a schematic illustration of a possible structure for a data structure used in the execution of the method according to the present disclosure, which has blocks generated by vehicle components that contain data regarding vehicle use.

The first block 21 in the data structure, unlike the other blocks, is not generated by one of the interconnected vehicle components during operation of the vehicle. Instead, it is already generated in at least one of the vehicle components during production of the vehicle, and permanently stored therein. This first block can also be formed in the framework of an initialization at the end of the production, in all of the vehicle components participating in the data exchange.

In order to obtain a shared data set as the starting point, or to obtain an initial consensus, arbitrary data can fundamentally be entered in a usage data section (English: payload) 25 of the first block 21. In the example shown herein, the mileage and hours in operation are set to zero. Information regarding the production of the vehicle, e.g. the year and location in which it was manufactured, can also be advantageously stored here. In addition, or alternatively, an identification number for the vehicle, e.g. the vehicle identification number, or the precise date of production, can also be stored.

The first block also contains a header (English: header) 24 in which a checksum obtained via the usage data is located. This makes it possible to protect the block prior to manipulation. So-called “hash functions” or “hash algorithms” can be used for this.

Each of the blocks 22 following the first block also has a header and a payload. The checksum for the immediately previous block is also stored in the header, such that a link is established between the two blocks.

Information is stored in the usage data in this example, which is acquired at a specific point in time during the use of the vehicle by one or more vehicle components or control units. As such, the current mileage reading and the current number of hours the vehicle is in operation is stored in the usage data at this time. Furthermore, a type of entry is noted in this example, indicating whether the acquired data were acquired while driving, during maintenance, in an accident, or during another event. In this example, a section of the usage data is reserved for other specific information, e.g. the type of accident.

A checksum is also obtained here for the usage data, which is stored in the header of the block in addition to the checksum for the preceding block. The obtained checksum is then used in turn to link the block to the subsequent data block. In this manner, an arbitrary number of data blocks can be linked together, starting from the first data block 21, and ending at the last data block 23.

In addition to the checksum, a timestamp can also be stored in the headers of the blocks, indicating the time when the respective block was generated, or the event was recorded therein.

Because numerous different electronic components and control units are currently incorporated in motor vehicles, these components can also store data in the respective blocks in the data structure in addition to the data described by way of example, or instead of the data specified herein.

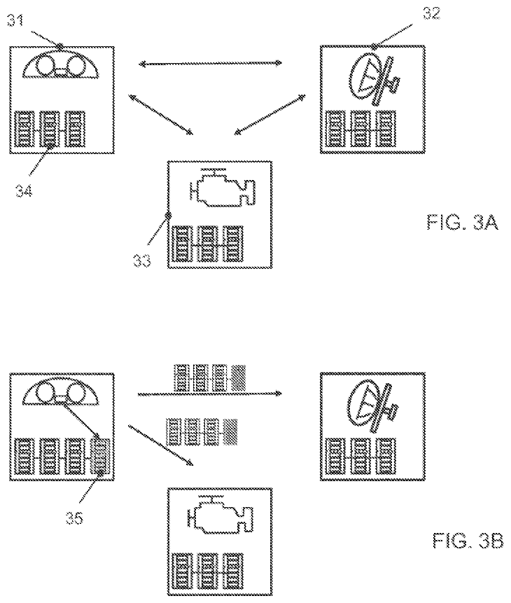

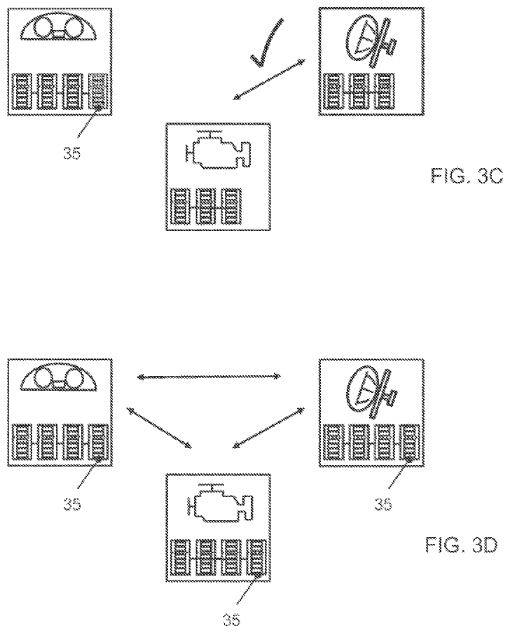

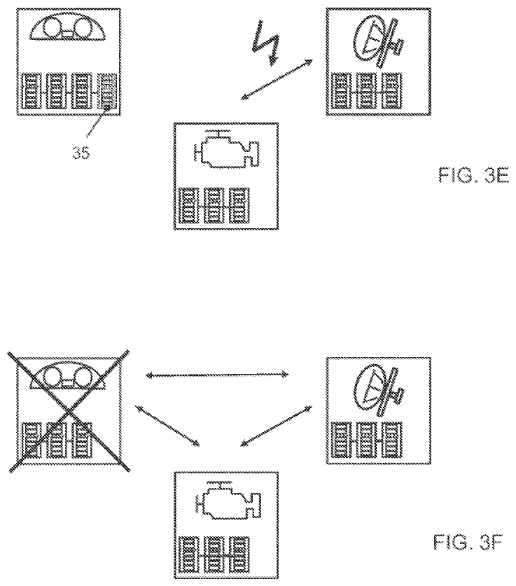

An example with the supplementation of the data structure by a new block, which is limited to three vehicle components 31, 32, and 33 for purposes of clarity, is shown schematically in FIG. 3.

The vehicle component 31, symbolized by a dashboard, provides the respective current mileage reading for the vehicle. Another vehicle component 32 can be an airbag control unit, for example, which outputs data in the event of an accident, e.g. the triggering of an airbag, or the severity of a crash. The last vehicle component 33 can be an engine control unit, for example, that outputs data regarding the hours in which the vehicle was in operation.

As FIG. 3A shows, each of the three vehicle components can exchange data with the other two vehicle components. The vehicle components can be connected to one another via a data bus for this, e.g. a CAN bus. It may also be possible for the vehicle components to communicate with one another wirelessly. Each of the vehicle components 31, 32, and 33 has the same data structure 34, which only contains three data blocks in this example, for purposes of simplicity.

If the vehicle component 31 then detects a new mileage reading, for example, at the end of a use of the vehicle, this is noted in a new block 35 by the vehicle component 31, as depicted in FIG. 3B. To enable a checking of the new block by the other vehicle components, the vehicle component 31 sends the data structure to which the new block has been added to the other two vehicle components 32, and 33. Instead of sending the entire data structure, just the new block can be sent for the check. The new block is then checked in the vehicle components 32, and 33 using the checksum contained in the new block.

If both vehicle components 32, and 33 come to the conclusion that the new block is valid, as indicated by the check mark in FIG. 3C, they then add their local version of the data structure to that of the vehicle. The data structure of the vehicle is assumed to be the data structure used by the majority of vehicle components in the vehicle at a certain time. They also share the positive result of their majority decision with the vehicle component 31, which in turn adds the new block to its version of the data structure. The same data structure, including the new block, is then present in all of the vehicle components, if there is a positive consensus, as shown in FIG. 3D.

If instead, the vehicle components 32 and 33 determine that there has been a manipulation of the data structure by the vehicle component 31 based on a deviation from the checksum, as shown in FIG. 3E, this vehicle component 31 is deactivated, or its scope of functions is at least temporarily restricted, as shown in FIG. 3F.

Other approaches are also possible here, depending on the extent to which the data structure in the vehicle component 31 deviates from the data structure for the vehicle.

If the data structure is entirely different than the data structure for the vehicle, it can be assumed that the vehicle component 31 originally came from another vehicle. The vehicle component 31 can then be locked, such that it first must be unlocked by an authorized entity in order to function. The resetting of a used vehicle component such that it can be authorized for use in another vehicle can be obtained through deleting the data structure stored therein, wherein the triggering of this deletion by unauthorized entities should be protected against. The first data structure received from another vehicle component is then adopted.

If only a slight deviation has been detected, for example, that only the last one or two blocks are missing from the data structure, but all of the preceding blocks have the correct checksums, it can be assumed that the vehicle component temporarily malfunctioned, and that these missing blocks can be restored by re-synchronizing with the data structure in the vehicle.

A brand new vehicle component subsequently installed in the vehicle has no data structure. In this case, the new vehicle component initially adopts the first data structure received from another vehicle component already installed in the vehicle, such that new vehicle components subsequently installed in the vehicle are immediately subjected to the component protection.

The present disclosure can be used for component protection in any electric vehicle components integrated in a vehicle, such as the various control units installed therein. It is also possible to receive the dedicated key for the vehicle in the component protection.

### LIST OF REFERENCE SYMBOLS

1 step for storing a first block in the data structure
2 step for acquiring data regarding vehicle use
3 step for generating a new block
4 step for sending the new block to other vehicle components
5 step for checking the validity of the new block
6 step for reaching a majority decision regarding the validity of the new block
7 step for supplementing the data structure
8 step for restricting use of the component
21 first block in the data structure
22 blocks following the first block in the data structure
23 last block in the data structure
24 header
25 usage data section
31, 32, 33 vehicle components
34 data structure stored in the vehicle components
35 new block in vehicle components

1-11. (canceled)

12. A method for protecting vehicle components, comprising:
acquiring data regarding vehicle use by at least two vehicle components;
generating a data structure containing a list of data regarding vehicle use, wherein the acquired data is stored in blocks that are linked together, wherein each block comprises a cryptographic checksum from the preceding block; and
storing the data structure in a plurality vehicle components in the vehicle, wherein the data structure is configured to verify the validity of at least one of the plurality of vehicle components.

13. The method according to claim 12, further comprising:
supplementing the data structure stored in a first vehicle component of the plurality of vehicle components with a new block comprising additional data regarding vehicle use, wherein the new block is added by the first vehicle component, and wherein the new block comprises a cryptographic checksum for a previously-last block in the data structure;
transmitting the new block to a least one of the other plurality of vehicle components; and
checking the validity of the added block using the cryptographic checksum and a version of the data structure located in the at least one other vehicle component.

14. The method according to claim 13, wherein checking the validity of the added block comprises checking the validity of the added block using three or more of the plurality of vehicle components, wherein validity is decided with a majority decision whether the new block is to be accepted.

15. The method according to claim 13, wherein the supplemented data structure is stored in the at least one other vehicle component if the results of the check of the new block are positive.

16. The method according to claim 13, further comprising restricting the scope of functions for the first vehicle component in the vehicle if the results of the check of the added block are negative.

17. The method according to claim 13, wherein a vehicle component in which a data structure has not yet been stored initially adopts the first data structure it receives from one of the other vehicle components.

18. The method according to claim 13, wherein the data regarding vehicle use comprises at least one of a mileage reading, information regarding times of use, GPS coordinates, and use identifications on the vehicle.

19. The method according to claim 12, further comprising deleting the data structure stored in the vehicle component in order to authorize use thereof in another vehicle, if a vehicle component was originally installed in another vehicle.

20. The method according to claim 12, wherein, if there is a different version of the data structure in the vehicle components previously stored in the vehicle, the data structure in at least some of the plurality of the vehicle components is used for validation.

21. A system, comprising:
a processor;
a memory, operatively coupled to the processor; and
a plurality of vehicle components operatively coupled to the processor, wherein the processor and memory are configured to:
acquire data regarding vehicle use by at least two vehicle components;
generate a data structure containing a list of data regarding vehicle use, wherein the acquired data is stored in blocks that are linked together, wherein each block comprises a cryptographic checksum from the preceding block; and
store the data structure in the plurality vehicle components, wherein the data structure is configured to verify the validity of at least one of the plurality of vehicle components.

22. The system according to claim 21, wherein the processor and memory are configured to:
supplement the data structure stored in a first vehicle component of the plurality of vehicle components with a new block comprising additional data regarding vehicle use, wherein the new block is added by the first vehicle component, and wherein the new block comprises a cryptographic checksum for a previously-last block in the data structure;
transmit the new block to a least one of the other plurality of vehicle components; and
check the validity of the added block using the cryptographic checksum and a version of the data structure located in the at least one other vehicle component.

23. The system according to claim 22, wherein the processor and memory are configured to check the validity of the added block by checking the validity of the added block using three or more of the plurality of vehicle components, wherein validity is decided with a majority decision whether the new block is to be accepted.

24. The system according to claim 22, wherein the processor and memory are configured to store the supplemented data structure in the at least one other vehicle component if the results of the check of the new block are positive.

25. The system according to claim 22, wherein the processor and memory are configured to restrict the scope of functions for the first vehicle component in the vehicle if the results of the check of the added block are negative.

26. The system according to claim 22, wherein a vehicle component in which a data structure has not yet been stored initially adopts the first data structure it receives from one of the other vehicle components.

27. The system according to claim 22, wherein the data regarding vehicle use comprises at least one of a mileage reading, information regarding times of use, GPS coordinates, and use identifications on the vehicle.

28. The system according to claim 21, wherein the processor and memory are configured to delete the data structure stored in the vehicle component in order to authorize use thereof in another vehicle, if a vehicle component was originally installed in another vehicle.

29. The system according to claim 21, wherein, if there is a different version of the data structure in the vehicle components previously stored in the vehicle, the processor and memory are configured to use the data structure in at least some of the plurality of the vehicle components for validation.

30. A method for protecting vehicle components, comprising:
acquiring data regarding vehicle use by at least two vehicle components;
generating a data structure containing a list of data regarding vehicle use, wherein the acquired data is stored in blocks that are linked together, wherein each block comprises a cryptographic checksum from the preceding block;
storing the data structure in a plurality vehicle components in the vehicle;
supplementing the data structure stored in a first vehicle component of the plurality of vehicle components with a new block comprising additional data regarding vehicle use, wherein the new block is added by the first vehicle component, and wherein the new block comprises a cryptographic checksum for a previously-last block in the data structure;
transmitting the new block to a least one of the other plurality of vehicle components; and
checking the validity of the added block using the cryptographic checksum and a version of the data structure located in the at least one other vehicle component.
